(19) United States
(12) Patent Application Publication
(10) Pub. No.: US 2006/0141170 A1
(43) Pub. Date: Jun. 29, 2006

(54) Optical film and method for manufacturing the same

(75) Inventors: Tung-lung Li, Pingzhen City (TW); Long-Hai Wu, Tucheng City (TW)

Correspondence Address: BRUCE H. TROXELL, SUITE 1404, 5205 LEESBURG PIKE, FALLS CHURCH, VA, 22041, US

(73) Assignee: Optimax Technology Corporation

(21) Appl. No.: 11/184,866

(22) Filed: Jul. 20, 2005

(30) Foreign Application Priority Data
Dec. 29, 2004 (TW) 93141204

(51) Int. Cl. C09K 19/00

(52) U.S. Cl. 428/1.3

(57) ABSTRACT

The present invention discloses an optical film comprising a substrate and a material layer. The material layer formed on the substrate further comprises a birefringent material and a dye material capable of absorbing light within a wavelength range. The present invention further provides a method for forming an optical film comprising steps of: preparing an absorbent solution by mixing a birefringent material and a dye material capable of absorbing light within a wavelength range into a solvent; forming a film by coating the absorbent solution on a top surface of a substrate; vaporizing the solvent contained in the film; and curing the optical film.

### FIELD OF THE INVENTION

The present invention relates to an optical film and a method for manufacturing the same and, more particularly, to an optical film and a method for manufacturing the optical film using a birefringent material doped with a dye material capable of absorbing light within a wavelength range so as to reduce color shifts at a wide viewing angle.

### BACKGROUND OF THE INVENTION

In conventional liquid crystal displays, such as transmission-type and reflection-type, for example, polarizers play a vital role in controlling the light passing through the liquid crystals. However, transmission remarkably decreases while light passes through the polarizers so that the efficiency of light will be limited and become even worse.

In order to overcome the problem described above, a prior art reference, U.S. Pat. No. 6,160,595, discloses a polarizing technique to obtain brighter display in a liquid crystal display apparatus. Referring to FIG. 1, a liquid crystal display is disclosed. The liquid crystal display comprises: an edge-lit backlight 91 with a reflector 90; a dichromatic polarizer 92; a quarter wave plate 93; and a liquid crystal panel 94 disposed in order. When light, radiated from the edge-lit backlight 91, passes through the dichromatic polarizer 92, a right handed circularly polarized light and a left handed circularly polarized light will be generated. For example, if the right handed circularly polarized light is transmitted and the left handed circularly polarized light is reflected, the right handed circularly polarized light will be converted into a linear polarized light after exiting the quarter wave plate 93. Meanwhile, the left handed circularly polarized light will be converted into right handed circularly polarized light after it is reflected from a reflector 90. Then the reflected right handed circularly polarized light will pass the dichromatic polarizer 92 again and be converted into the linear polarized light after exiting the quarter wave plate 93.

Although the prior art can enhance brightness of the liquid display and achieve a wide viewing angle, it results in a problem that color shifts occur at the wide viewing angle. Referring to FIG. 2, the drawing illustrates the transmission spectrum of the dichromatic polarizer 92 in FIG. 1. A curve marked 1 in the drawing indicates the transmission spectrum while the viewing angle is 90 degrees, i.e., perpendicular to the dichromatic polarizer 92. At this viewing angle, the transmission rate is almost the same in the region of the visible light (400 nm to 780 nm). Therefore, rich color and enhanced brightness will be obtained. However, while the observer views the polarizer at an included angle over 90 degrees, the curve 1 will shift towards the left side of the drawing like another curve 2 illustrated in FIG. 2. The curve 2 indicates that the region of red light spectrum has a higher transmission rate because red light is less reflected. Because of the higher transmission rate of red light, the color will shift to red at the included angle, i.e. the wide viewing angle.

To avoid the issue of color shifts, some techniques are proposed to solve this problem. For example in U.S. Pat. No. 5,731,886 entitled “Birefringent Compensator for Reflective Polarizers”, Taber et al. issued Mar. 24, 1998, the invention comprises a circular dichroism material layer and a compensator comprising a uniaxial film with an optical axis perpendicular to the surfaces of the film. The compensator is inserted on the path of light transmitted through the circular dichroism material layer, and incorporated into a brightness enhancement system for a liquid crystal display.

European Patent Application EP 0860717 A2 proposes to improve the viewing angle behavior of the broadband circular polarizers by using compensation films, which are uniaxial and have their optical axes perpendicular to the surfaces. The compensation films typically consist of two layers. The first layer closer to the circular polarizer has a positive birefringence, and the second layer has a negative birefringence. These two-layer compensation films may be inserted in front of and/or at the back of the circular polarizer.

Because of high manufacturing cost for the prior art listed above, it is necessary to propose an optical film and a method for manufacturing the same so as to solve the problem of the prior art.

### SUMMARY OF THE INVENTION

The main object of the present invention is to provide an optical film and a method for manufacturing the same to absorb light within a wavelength range.

A further object of the present invention is to provide an optical film and a method for manufacturing the same by utilizing a birefrigent material with dyes to form the optical film so as to achieve low cost and easy manufacture.

Still a further object of the present invention is to provide an optical film and a method for manufacturing the same by utilizing a birefrigent material with dyes to form the optical film capableof being combined with a liquid crystal display so that a problem of color shifts at a wide viewing angle can be solved.

In order to achieve the foregoing objects, the present invention provides an optical film that comprises: a substrate; and a material layer, formed on the substrate, the material layer comprising a birefringent material and a dye material capable of absorbing light within a wavelength range.

The present invention discloses a method for manufacturing an optical film comprising steps of: preparing an absorbent solution by mixing a birefringent material and a dye material capable of absorbing light within a wavelength range into a solvent; forming a film by coating the absorbent solution on a top surface of a substrate; vaporizing the solvent contained in the film; and curing the optical film.

### BRIEF DESCRIPTION OF THE DRAWINGS

The drawings, incorporated into and form a part of the disclosure, illustrate the embodiments and method related to this invention and will assist in explaining the detail of the invention.

FIG. 1 illustrates optical paths of light passing through the dichromatic polarizer disposed in conventional liquid crystal display.

FIG. 2 shows the transmission spectrum at different viewing angle while light passes through the dichromatic polarizer.

FIG. 3 illustrates a preferred embodiment of an optical film according to the invention.

FIG. 4 illustrates another preferred embodiment of an optical film according to the invention being combined with a liquid display.

FIG. 5 is a flow chart of a method for forming an optical film according to the present invention.

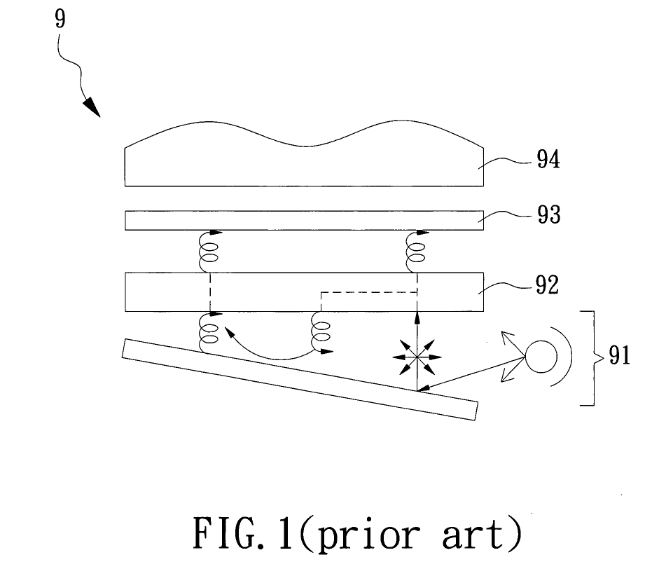

### DESCRIPTION OF THE PREFERRED EMBODIMENT

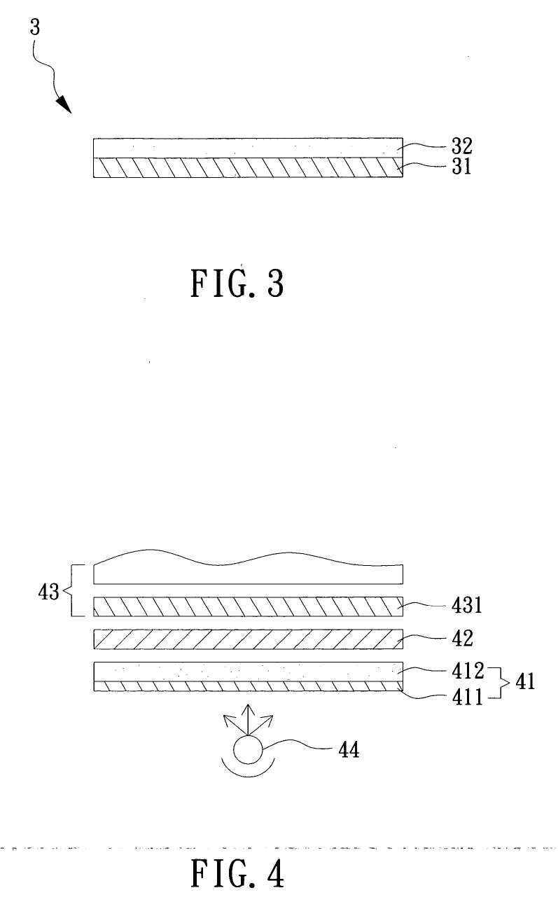

FIG. 3 illustrates a preferred embodiment of an optical film according to the invention. The present invention discloses the optical film 3 that comprises a substrate 31 and a material layer 32. The material layer 32 formed on the substrate 31 further comprises a birefringent material and a dye material capable of absorbing light within a wavelength range. The substrate 31 can be a transparent material such as a polymer material, or a glass material, for example.

The dye material is one selected from a group comprising an azo pigments material, a quinoline material, an anthraquinone, and a nitro-diphenylamine. In this embodiment, the birefrigent material is capable of dividing an unpolarized incident light into a first circularly polarized light transmitted therethrough and a second circularly polarized light reflected thereon. The circular direction of the first circularly polarized light is different from that of the second circularly polarized light. For example, the first circularly polarized light can be a right handed polarized light while the second circularly polarized can be a left handed polarized light.

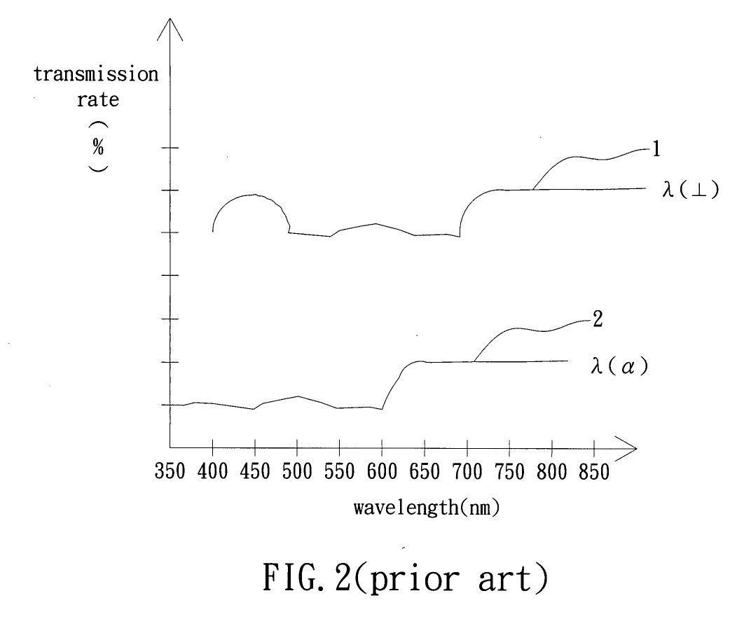

FIG. 4 illustrates another preferred embodiment of an optical film disposed in a liquid display. In this embodiment, the optical film 41 is combined with a liquid crystal display 43. The combination comprises the optical film 41, a quarter wave plate 42, a liquid crystal panel 43, and a backlight device 44. The optical film 41, disposed between the backlight device 44 and a rear polarize 431 of the liquid crystal panel 43, comprises a substrate 411 and a material layer 412 wherein the material layer 412 formed on the substrate 411 further comprises a birefringent material and a dye material capable of light within a wavelength range. The quarter wave plate 42 is disposed between the rear polarizer 431 and the optical film 41. In this embodiment, the region of optical wavelength ranges from 620 to 780 nanometers, which is the optical wavelength region of red light spectrum. The dye material is one selected from a group comprising an azo pigments material, a quinoline material, an anthraquinone, and a nitro-diphenylamine. In this embodiment, the birefrigent material is capable of dividing an unpolarized incident light into a first circularly polarized light transmitted therethrough and a second circularly polarized light reflected thereon. The circular direction of the first circularly polarized light is different from that of the second circularly polarized light. For example, the first circularly polarized light can be a right handed polarized light while the second circularly polarized can be a left handed polarized light. Because the transmitted rate of red light is high, as shown in FIG. 2, when users observe the liquid crystal panel at a wide viewing angle, the color shift problem will occur. Therefore, with the combination of the optical film 41 and the liquid crystal panel 43, the problem of color shifts will be overcome to exhibit a better visual performance.

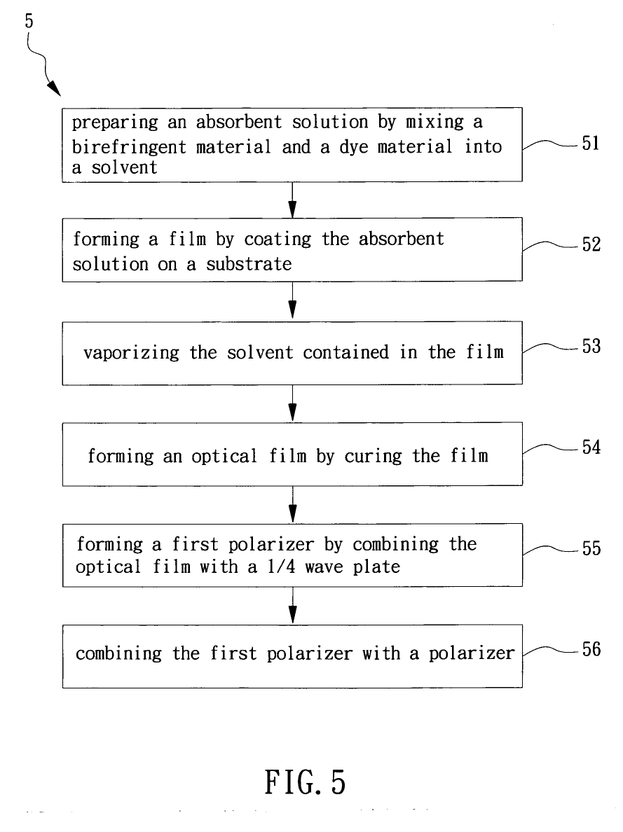

Referring to FIG. 5, a method for forming an optical film illustrated in a flow chart is shown in the drawing. The flow 5 comprises steps of:
Step 51—preparing an absorbent solution by mixing a birefringent material and a dye material capable of absorbing light within a wavelength range into a solvent;
Step 52—forming a film by coating the absorbent solution on a top surface of a substrate;
Step 53—vaporizing the solvent contained in the film; and
Step 54—curing the optical film.

In this embodiment, the wavelength region ranges from 620 to 780 nanometers, which is the optical wavelength region of red light. The dye material is one selected from a group comprising an azo pigments material, a quinoline material, an anthraquinone, and a nitro-diphenylamine. In this embodiment, the birefrigent material is capable of dividing an unpolarized incident light into a first circularly polarized light transmitted therethrough and a second circularly polarized light reflected thereon. The circular direction of the first circularly polarized light is different from that of the second circularly polarized light. For example, the first circularly polarized light can be a right handed polarized light while the second circularly polarized can be a left handed polarized light. In the step 53, the coating step is achieved by spin coating, spray coating, dip coating, or roll coating. In Step 54, the curing step is one selected from a group comprising an ultra violet curing step and a thermal curing step.

The flow 5 further comprises Step 55 of forming a first polarizer by combining the optical film with a quarter wave plate and a step 56 of combining the first polarizer with a polarizer wherein the polarizer is a rear polarizer disposed in a liquid display.

While the present invention has been described and illustrated herein with reference to the preferred embodiment thereof, it will be understood by those skilled in the art that various changes in form and details may be made therein without departing from the spirit and the scope of the invention.

What is claimed is:

1. An optical film, comprising:
a substrate; and
a material layer, formed on said substrate, said material layer comprising a birefringent material and a dye material capable of absorbing light within a wavelength range

2. The optical film according to claim 1, wherein said substrate is substantially a transparent material.

3. The optical film according to claim 2, wherein said transparent material is one selected from a group comprising a polymer material and a glass material.

4. The optical film according to claim 1, wherein said wavelength range is from 620 to 780 nanometers.

5. The optical film according to claim 1, wherein said dye material is one selected from a group comprising an azo pigments material, a quinoline material, an anthraquinone, and a nitro-diphenylamine.

6. The optical film according to claim 1, wherein said optical film is disposed between a rear polarizer of a liquid crystal display and a backlight source to avoid color shift at a wide viewing angle.

7. The optical film according to claim 6, wherein a quarter-wave plate is disposed between said rear polarizer and said optical film.

8. The optical film according to claim 1, wherein said birefrigent material is capable of dividing an unpolarized incident light into a first circularly polarized light transmitted therethrough and a second circularly polarized light reflected thereon.

9. A method for manufacturing an optical film, comprising steps of:
preparing an absorbent solution by mixing a birefringent material and a dye material capable of absorbing light within a wavelength range into a solvent;
forming a film by coating said absorbent solution on a top surface of a substrate;
vaporizing said solvent contained in said film; and
curing said optical film.

10. The method according to claim 9, wherein said substrate is substantially a transparent material.

11. The method according to claim 10, wherein said transparent material is one selected from a group comprising a polymer material and a glass material.

12. The method according to claim 9, wherein said wavelength range is from 620 to 780 nanometers.

13. The method according to claim 9, wherein said dye material is one selected from a group comprising an azo pigments material, a quinoline material, an anthraquinone, and a nitro-diphenylamine.

14. The method according to claim 9, wherein said curing step is one selected from a group comprising an ultra violet curing step and a thermal curing step.

15. The method according to claim 9, wherein said birefrigent material is capable of dividing an unpolarized incident light into a first circularly polarized light transmitted therethrough and a second circularly polarized light reflected thereon.

16. The method according to claim 9, further comprising a step of:
forming a first polarizer by combining said optical film with a quarter wave plate.

17. The method according to claim 16, further comprising a step of:
combining said first polarizer with a polarizer.

18. The method according to claim 17, wherein said polarizer is a rear polarizer of a liquid display device.
